(19) United States
(12) Patent Application Publication
(10) Pub. No.: US 2020/0316625 A1
(43) Pub. Date: Oct. 8, 2020

(54) Ironwood Timber Marking Paint System

(71) Applicant: Eli Christian Jensen, Chino Valley, AZ (US)

(72) Inventor: Eli Christian Jensen, Chino Valley, AZ (US)

(21) Appl. No.: 16/840,141

(22) Filed: Apr. 3, 2020

Related U.S. Application Data
(60) Provisional application No. 62/829,481, filed on Apr. 4, 2019.

(51) Int. Cl. B05B 9/08; A01G 23/06; A01G 23/08

(52) U.S. Cl. CPC B05B 9/0833; A01G 23/08; A01G 23/06

(57) ABSTRACT

A timber marking system includes a portable back pack mounted user, the pack carrying a paint storage tank and a pressurized gas tank. The storage tank is pressurized and coupled with a manually operated trigger to allow filed operated timber marking. A method to mark timber includes preparing the tank system with pressurized gas, selectively marking a preidentified tree at the trunk and stump.

### CLAIM OF PRIORITY

The present application includes subject matter disclosed in and claims priority to a provisional application entitled “Ironwood Timber Marking Paint System” filed Apr. 4, 2019 and assigned Ser. No. 62/829,481, incorporated herein by reference, describing an invention made by the present inventor.

### BACKGROUND OF THE INVENTION

### 1. Field of the Invention

The present invention is related to the logging industry, and more particularly directed to timber marking paint systems, as are known in the art to mark trees and/or stumps for timber, cutting, and removal.

### 2. Description of Related Prior Art

Trees must be marked according to United States Department of Agriculture Forest Service Guidelines. Relevant guidelines are found in USDA Forest Service Handbook FSH 2409.12—Timber Cruising Handbook Chapter 70 (Designating Timber for Cutting), such as Amendment No. 2409.12-2009-1, Effective Dec. 1, 2009, et seq. Tree marking is a forest management technique used in forests around the world. Individual trees are marked in a forest stand before the stand is “treated”, or has some of the trees cut.

Tree marking is used in industrial forestry to ensure that forestry contractors who are using machinery to harvest wood are cutting the correctly identified trees. This allows a forester to maximize the efficacy of a silvicultural treatment as prescribed for the stand. Timber marking also allows monitoring and easy auditing. Each tree is marked in at least two places along the trunk, and along the ground/stump (lower trunk mating with the ground, potentially surrounding ground surface, and directly thereabove) so that after clearing, the removed trunks should bear marking, and the remaining stump should also bear marking.

Tree marking, in its most basic form, consists of painting to mark trees in one, or more frequently, two colors. The first color, often orange or yellow, is used to designate trees that are to be cut by the harvesting machine or sawyer. The second color, blue or otherwise, is used to mark trees that will be kept and should not be cut. Black paint is often used to cover an improperly marked tree. Flagging tape is often wrapped around a tree, or trees, to designate the boundary of a specific unit or stand (section).

Silvicultural management via spacing helps to reduce resource competition amongst the trees, while managing light fall/access to the forest floor. Managing light encourages the establishment and growth of saplings and other plants.

Healthy trees are often selected for retention, while those exhibiting defects that affect longevity, form (quality and value) are selected for removal. For instance, conks may indicate rot; broken tops could be the result of ice or wind damage, as well as any number of forest pests; cankers are often an indicator or fungal or bacterial infection; small, unhealthy tops are also an indicator of tree stress and could be a reason to mark a tree to cut. Spacing further serves to support and secure healthy trees from undesirable competition.

The decision-making process of foresters usually involves wildlife features. In an industrial setting, there is often a minimum requirement of wildlife trees marked per hectare. If a living tree has a good cavity where a bird or animal could make a nest those trees are often kept. Nest trees are also kept, and often given a buffer of untouched trees in order to secure the creature inhabitants remain undisturbed. Trees that look unhealthy but are being used extensively by woodpeckers are also good candidates for retention. Mast trees that are large and healthy provide sustenance for a wide variety of animals and birds via seeds, nuts, and berries, etc. Beech trees with bear claw marks are often preserved for beech-nuts. Desirable tree species that provide a good strong seed source for future saplings may be kept. Similarly, super canopy trees (noticeably taller or have a broad extensive canopy such as “wolf” white pines) may be kept for functionality. Tree marking benefits the entire stand when accomplished according to silvicultural prescription.

Marking trees often involves hand-pump systems that must be manually carried. These systems have low volume capacity and therefore must be replenished often. Distance from electrical power sources serves to require markers to provide power source for spraying, often pumping. When paint canisters are exhausted, the marking official must return for resupply. Additionally, frequent stopping can be disruptive to mental processes, and otherwise slow down the process. Tree markers need a useful, large storage, and convenient method to mark trees.

It is therefore an object of the present invention to provide a method for timber marking that allows for minimizing labor effort.

It is a further object of the present invention to increase efficiency of timber marking individuals.

It is another object of the present invention to provide a timber marking tool.

These and other objects of the present invention will be clarified in the following description.

### SUMMARY OF THE INVENTION

The present invention is directed to a pack-mounted gas-pressurized timber marking paint system for marking trees and/or stumps. The tank system includes a pressurized source of gas, such as a carbon dioxide tank. The gas tank may be fitted with a pressure regulator. The gas or pressure tank is in fluid communication with a lead line past the pressure regulator. The lead line fits into a manifold on a paint storage tank. The lead line may be removably coupled to a first manifold on the gas tank at a first port. The lead line other end is connected to a second manifold at the storage tank, along a pressure port. The pressure port or second manifold may be outfitted with a pressure shut-off valve to isolate the two tanks. The storage tank also may include a dispensation or spray port coupled with a spray line and spray emitter.

The gas tank and the storage tank are carried by the back pack, and may be contained therein. The tanks may be set within pressurized source of gas and said storage tank are housed within a shoulder-mountable back pack, and each tank may include a separate compartment within the pack.

The dispensation line may include its own valve along its own manifold along the surface the storage tank, and a second trigger valve at the opposite side of the dispensation line at the spray gun. The storage tank may also include a third port with an air chuck mounted thereon.

The present invention also includes a method of marking timber with a pressurized tank sprayer system. After filling a storage tank with a marking paint, the storage tank is sealed close via a lid. The storage tank is coupled to a pressure tank on a pressure regulated line. Initially closed at no added pressure, a valve on a manifold on the storage tank may be opened. The pressure regulator can be raised to prelease gas from gas tank and supply to storage tank, thus pressurizing the storage tank. A supply line is also set along the storage tank and may include a supply port with a valve. This supply valve is opened allowing pressure to transfer along a supply line to an emitter, such as a spray gun. Paint is selectively emitting from the emitter onto a trunk of a targeted tree, and then again onto the stump (or just above the ground). When completed, the pressure valve is closed, and the pressure regulator may be set closed. The pressure line can then be removed from the manifold on the storage tank, and then the valve slowly opened to release pressure within the storage tank. The storage tank can then be opened and refilled. Once filled, it can then be resealed and the process repeated. The back pack is carried in the field for timber marking operations. The user identifies a target tree for removal and then sprays it. The tree can then be removed.

### BRIEF DESCRIPTION OF THE DRAWINGS

The present invention will be described with greater specificity and clarity with reference to the following drawings, in which:

FIG. 1 demonstrates an assembled view of the dual tank system of an embodiment of the present invention.

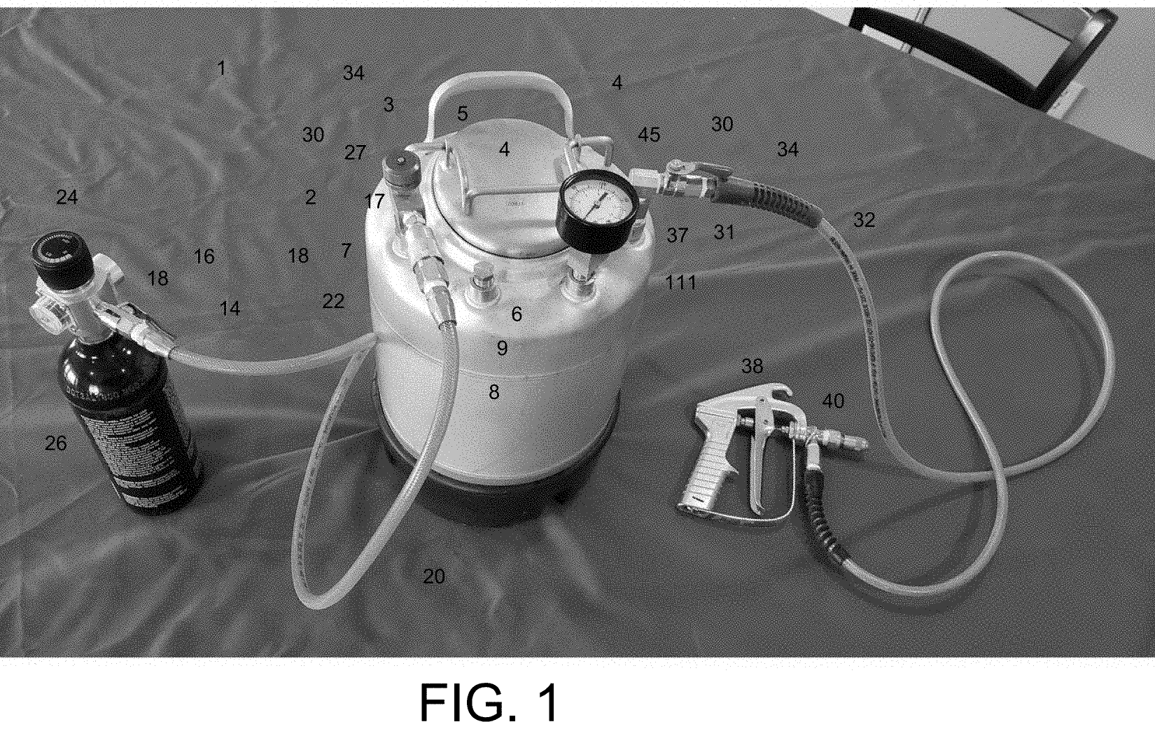

FIG. 2 demonstrates an exploded view of the dual tank system of an embodiment of the present invention.

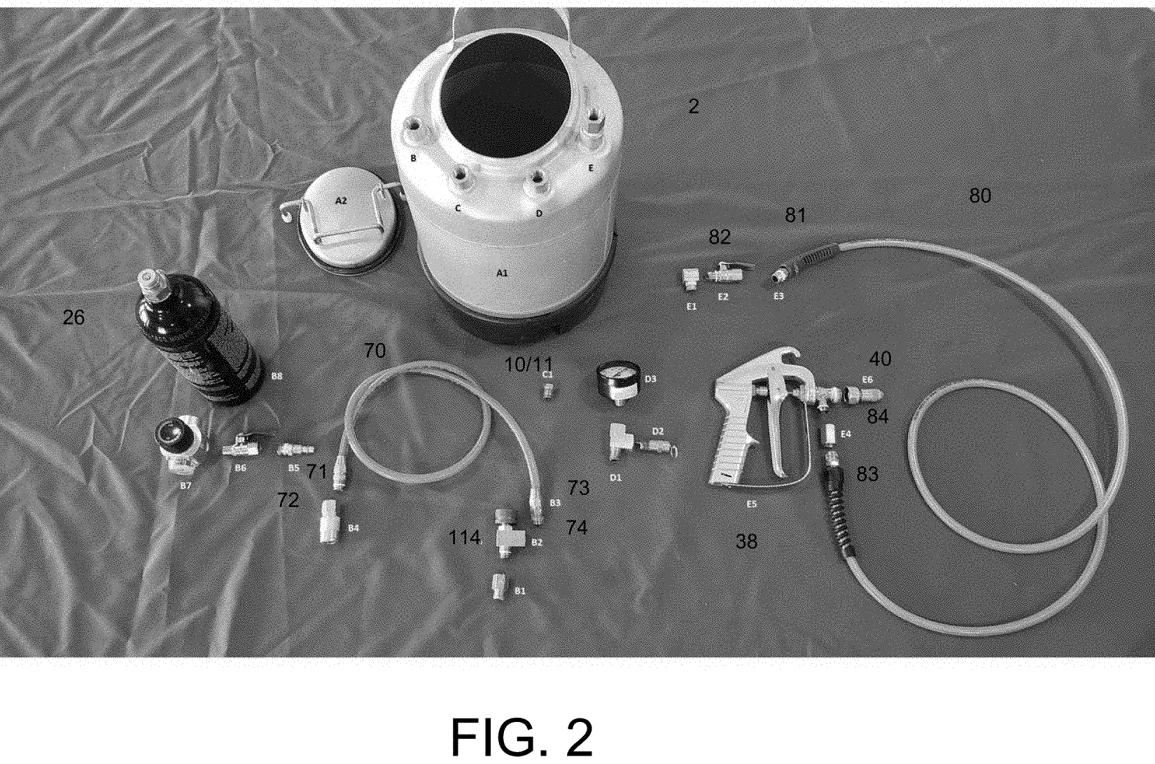

FIG. 3 demonstrates an open back pack displaying interior contents of an embodiment of the present invention.

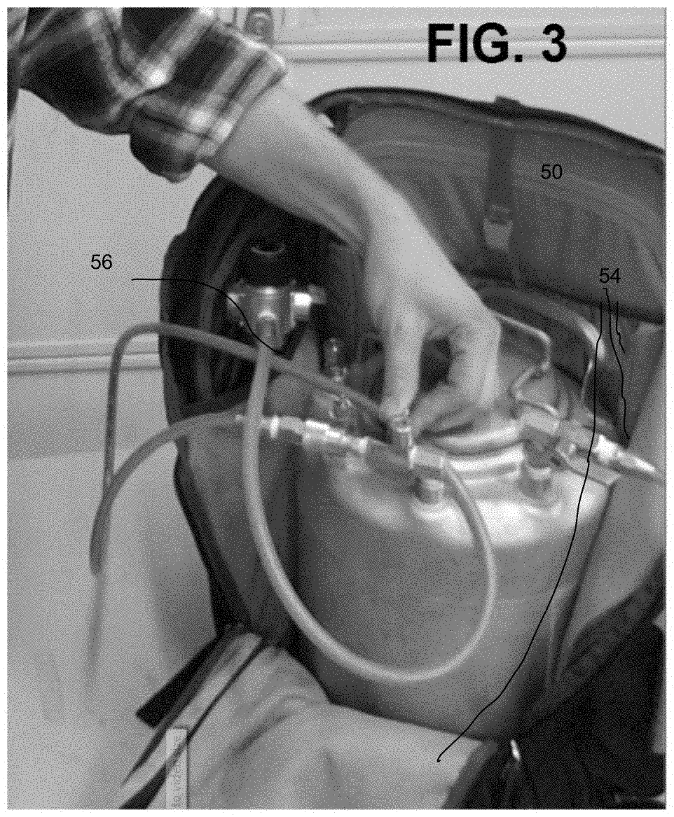

FIG. 4 demonstrates spraying tree trunk with back-mounted canister and timber marking system.

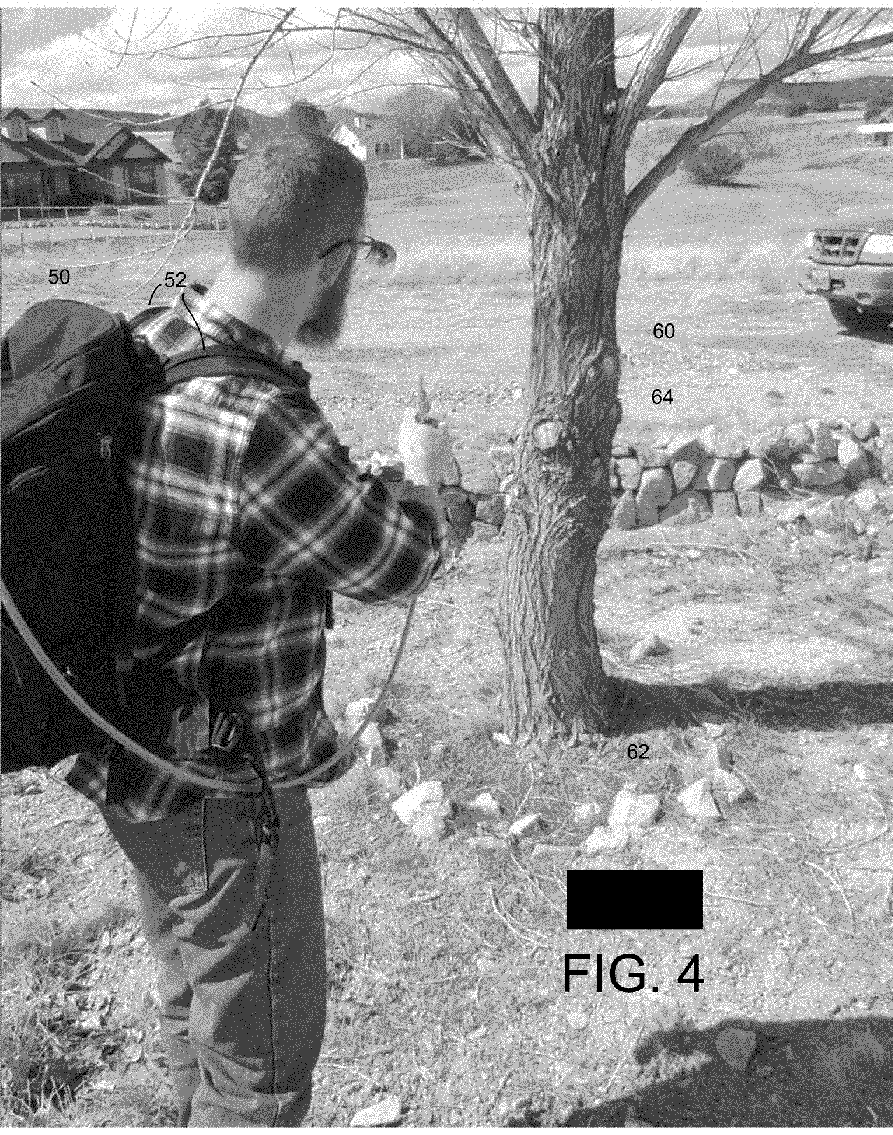

FIG. 5 demonstrates spraying trunk stump with back-mounted canister and timber marking system.

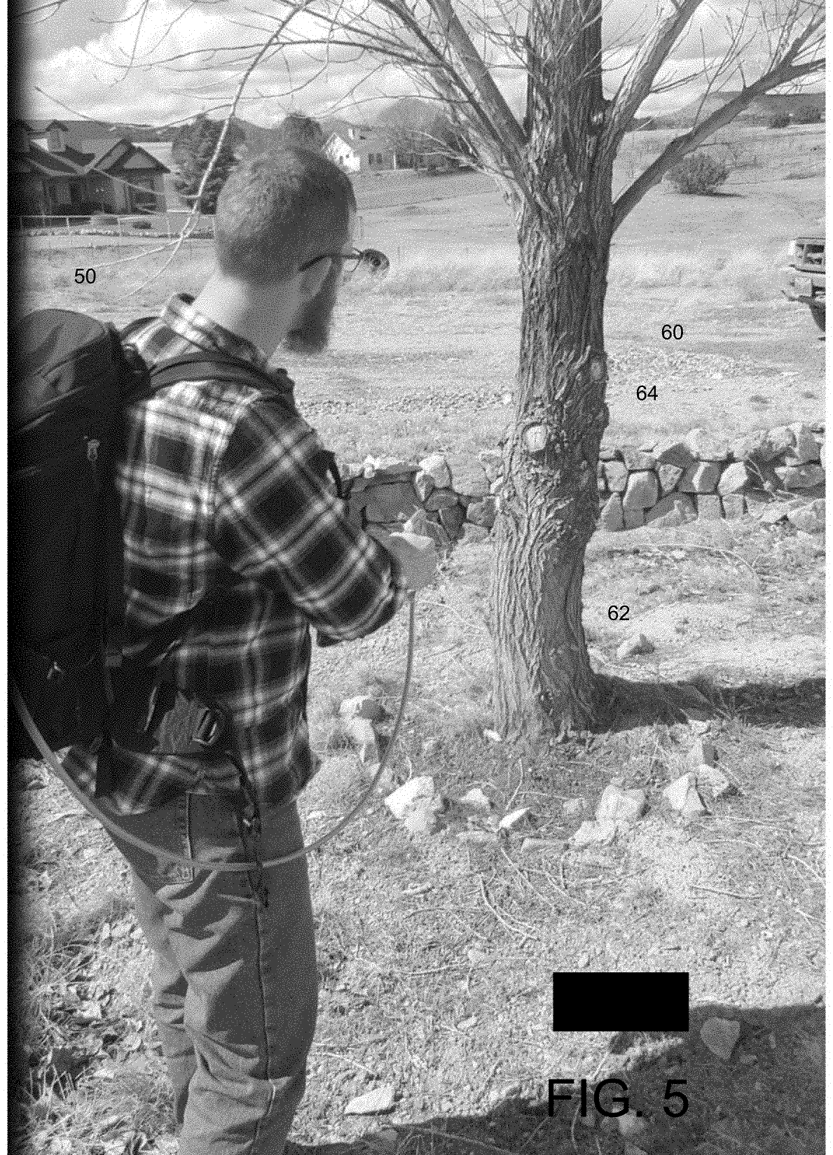

### DETAILED DESCRIPTION OF THE PREFERRED EMBODIMENT

The present invention can be best understood through review of the embodiments below. A timber marking back pack can be assembled and used for timber marking. The back pack contains two tanks, a compressed gas tank, and a fill tank containing the marking paint.

Tank system 1 must first be assembled in the transportable pack 50. Construction of back pack is essential to allow simultaneous and fluid communication coupling of compressed gas tank, paint tank, and sprayer. Similar back packs suitable include a ruck pack supplied by REI, or the like, modified for containing the tank systems. Pack 50 contains both paint tank 2 and compressed gas tank 26, preferably within a main compartment. In alternative embodiments, pack may allow carrying of tanks in separate compartments, or to hang from a harness for access by the user during carrying operation. Most preferably, separate internal compartments house the tanks.

Compressed gas tank 26 provides both pressure and energy to force paint through system to allow marking at distances sufficient for timber marking, such as up to six to twelve feet, or more. Tank 2 is placed within pack 50 in a tank pocket 54. Tank 2 includes lid 4 and is intended to provide a pressure seal on tank 2. To close paint tank 2, lid 4 is pulled upwards until it seats properly along tank opening rim 3. Lever 5 is pressed or rotated down to close lid 4 onto tank 2. Supply hose 21 is set opposite and interior to spray port 37, and includes far end 41 set or fixed at a low end or low point within the paint tank.

Tank 2 may include multiple ports, including first port 7 with a cap 6 set thereon. Cap is screwed into port 7. Safety relief valve 8 is preferably also located on tank 2 at relief port 9 and provides for safety pressure relief. Gas port may also be included on tank 2 providing access to pressure tank 26. Spray port 37 is also provided, and couples internally with supply hose 21.

Pressure system is installed into tank 2 from compressed gas tank 26. Compressed gas tank is preferably a source of compressed carbon dioxide as a low cost nonflammable pressurized or liquified gas. Compressed gas tank may be filled with a gas or mixture of gases, or a liquid, liquified, dissolved, or solid with vapor pressure as is known in the art (e.g. exceeding 40 psi at 100° F., etc.), such as ambient air, noble gas (i.e. argon, helium, etc.), nitrogen, oxygen, liquified nitrogen, etc., while preferred gases are nonflammable. Compressed gas tank 26 fits into pressure tank pocket 56. Tank tube 70 connects compressed gas tank 26 with paint tank 2 at pressure or gas port 27. Starting at compressed gas tank 26, and to install the gas pressure system, an assembly is attached to outlet gas port 17 on compressed gas tank 26. Fitting 34 is set over gas port 17 with at least two access points, one for a pressure regulator 24 and the other to (female) coupling 18. First end 71 of tank tube 70 is coupled via coupler 72 into female coupling 18. The far end 73 of tube 70 is connected to an assembly at paint tank via coupler 74 over pressure port 37. Elbow 28 may be used to mate with paint tank pressure port 37 to allow inclusion of ball valve 14. Ball valve 14 may be any manually or automatic (e.g. via solenoid), or otherwise operated valve. Manual operation is preferred for ball valve 14, however, an electronic signal receiver, either wired or wireless maybe used. The use may include a handheld device which activates the valves, and otherwise may control operation of the valving system as between the tanks. An automatic protocol may be used to allow for pressurization and unpressurization of tank 2. Alternatively, a gate valve 114 may be used to allow more control over slow release of pressures from tank 2. A connection point, preferably male quick connect 31, fits over into ball valve 14. Heavy duty screw 10 and/or air chuck 11 maybe used over other ports on tank. Air chuck acts as an adapter for inclusion of additional units. In the alternative, pressure gauge 111, may be set on port. One should be warned not to connect the female coupling 36 to the male coupling quick connect until after final assembly when the tank is ready to be pressurized.

To install the paint marking gun on tank 2 spray port 45, street elbow 41 fits on port 45 and connects with spray ball valve 42. Similar elbow 43 and valve 44 may be used to activate/deactivate sprayer. Spray hose 80 includes near end 81 with coupler 82 to fit into coupler 46 on spray port assembly. Far end 83 of hose 80 is connected to spray gun 38 using far end coupler 84.

With lid 4 removed, tank 2 may be filled with timber marking paint. Lid 4 may be set over rim 3 and closed via lever 5 to provide a pressure seal (optional gasket may be used to assist in seal). Tube 70 may be attached to paint tank 2 thus joining paint tank 2 and compressed gas tank 26 while valve 30 is closed and pressure regulator 24 is set to zero (i.e. closed). Once connected, pressure regulator 24 adjusted to the desired pressure (typically 60-80 PSI for normal timber marking operations) and then tank valve 30 is opened to allow pressurization of paint tank 2. Once the paint tank is pressurized, it is ready for use. To prevent excess loss of CO₂, one should stop use immediately after the spray gun sputters (indicating low paint level), by first closing valve 30, turning regulator 24 to 0 (closed) and then removing tube 70. Pressure valve may then be opened to slowly release pressure on tank 2 and allow opening to refill.

To refill tank 2, close ball valve 30 and disconnect tube 70. Slowly open the ball valve 30 to release the pressure inside the tank 2. Once all of the pressure has been released from tank 2, open lid 4 and refill with marking paint.

When not in use, lid 4 should be secured to prevent paint in the tank 2 from drying or spilling. Spray gun 38 fits on other end of hose 80 and includes spray tip 40, and tip should be removed and cleaned and placed in water (or other useful liquid) to prevent paint from drying and clogging the tip. Alternatively, the entire spray gun with tip should be placed in water, or the like.

Once the tank is filled with a marking paint (or other liquid), the tank lid is closed. The tank may be filled with a fluid, including water, liquid, solid for sublimation or melting, a gas, or combination of any of same that when combined in the dispensation line provides a marking fluid.

Pressure hose 70 is used to connect the compressed gas tank 26 to the paint tank manifold or assembly 39. Tank manifold 39 may include a preferably open, or closed, valve 30 prior to connecting the compressed gas tank. Once installed, the compressed gas tank (held in pocket 56) can be opened via setting a pressure regulator 24 to set the tank and line pressurized system. After use of system 1, when tank 2 nears empty of paint, tank manifold 39 valve 30 is closed (keeping paint tank pressurized). Next, the pressure tank 26 and regulator 24 may be set/closed. Compressed gas tank 26 can then be disconnected from tank 2 by removing tube 70 from assembly 39. Tank lid can then be safely opened to refill with paint.

When properly filled and pressurized, a timber marking user with back pack mounted can easily spray to mark a tree or stump with the pressurized paint system. A triggered spray emitter is preferred for spray gun 38. The tree 60 including both trunk 64 and stump 62 can be painted at a distance. User can equip or wear the pack, preferably as a standard back pack with two shoulder straps. Spray gun may be handheld and squeeze trigger operated (or otherwise as known in the art). User approaches selected tree at a distance and sprays once to cover trunk and stump, or in two separate sprays. As trigger is squeezed, pressurize paint tank releases pressure through spray hose and paint is taken up through spray hose to gun and out tip to be directed at force against target. As paint flows through spray gun, pressure regulator on pressure tank maintains pressure in paint tank at set level to maintain a consistent pressure and spray distance through operation. Preferably, when spray trigger is released, paint tank quickly repressurizes from compressed gas into paint tank, and pressure/paint tanks reach equilibrium at preset pressure (via regulator). If pressure tank is exhausted, user will note low pressure paint spray. If paint tank is low, sputtering may occur at tip and user will be notified to reload. In some instances, it may be preferable to maintain a smaller paint tank and carry additional paint in separate paint reservoir. User can then refill paint tank in the field from a reservoir and continue operation. Alternative embodiments of the system may include alternative pressure systems, including battery/electrical motor pumps, or otherwise.

### PARTS

A
A1 Apache Stainless Equipment Corporation Model 90-3 Tank
A2 Apache Stainless Equipment Corporation Model 90-3 Lid
B
B1 Adapter, ¼″ Male Pipe×¼″ Female Pipe
B2 National Valve Shut Off Valve Model R9432B-2MF, ¼ NPT, Right Angle
B3 ¼″ NPT Quick Disconnect Male
B4 ¼″ NPT Quick Disconnect Female
B5 300 PSI Polyurethane Air Hose ¼″ with Reusable Replacement Fitting For ¼-Inch ID Hose
B6 Brass Mini Ball Valve, 180 Degree Operation Handle ¼″ NPT Male×¼″ NPT Female
B7 Interstate Pneumatics WRC2 CO2 Regulator—Solid Aluminum Body 0-125 PSI
B8 20 oz CO2 Pinvalve Cylinder Tank
C
C1 ¼″ NPT Cap
D
D1 Street Tee, ¼″ Female Pipe×¼″ Male Pipe×¼″ Female Pipe
D2 ¼″ NPT 150 PSI Air Compressor Safety Relief Pressure Valve
D3 Air Pressure Gauge 2″ Dial, Center Back Mount, ¼″ NPT, 0-200 PSI
E
E1 90 Degree Barstock Street Elbow, ¼″ NPT Male Pipe to ¼″ NPT Female Pipe
E2 Brass Mini Ball Valve, 180 Degree Operation Handle ¼″ NPT Male×¼″ NPT Female
E3 300 PSI Polyurethane Air Hose ¼″ with Reusable Replacement Fitting For ¼-Inch ID
Hose
E4 ¼″ NPT Female Coupling
E5 AA23L GunJet Spray Gun
E6 5500 Brass ConeJet Adjustable Spray Tip

### Assembly

A

To assemble the Apache 90-3 tank, place the lid (A2) inside the tank (A1) and pull upwards until it seats properly, pushing the lever down to close.

B

To install the CO2 pressure system, screw the adapter (B1) onto the male end of the right angle shut off valve (B2) and the male quick disconnect (B3) into the female end of the right angle shut off valve (B2). Screw the adapter (B1) into port B until the male quick disconnect (B3) faces port C. Screw the female quick disconnect (B4) onto one end of the hose (B5) and the mini ball valve (B6) onto the other end of the hose (B5). Then screw the mini ball valve (B6) into the pressure regulator (B7). When the system is ready for use, attach the CO2 tank (B8) to the pressure regulator (17).

C

The ¼″ NPT cap (C1) is screwed into port C

D

Screw the safety pressure relief valve (D2) into the female end of the tee (D1) perpendicular to the male end. Screw the air pressure gauge (D3) onto the female end of the tee (D1) opposite of the male end. Then screw D1 into port D.

E

To install the paint marking gun, first connect the street elbow (E1) and the ball valve (E2), then screw parts E1-2 into port E. Screw one end of hose (3) onto the ball valve (E2). Connect the other end of the hose (E3) to the the spray gun (E5) using the female coupling (E4). Attach the spray tip (E6) onto the spray gun (E5)

Use

Once assembled, remove the lid (A2) and fill the tank (A1) with timber marking paint. Re-attach the lid (A2). Open valve B2. Close valve B6. Adjust the pressure regulator (B7) to the desired pressure (60-120 psi recommended). Connect the female (B4) and male quick disconnects (B3). Open valve B6. The tank (A1) should now pressurize. With valve E2 open, the system may now be used to spray timber marking paint. To make adjustments to the marking gun (E5) or to change the tip (E6) while the tank (A1) is pressurized, close valve (E2).

To depressurize the tank, close valve B2. Remove the female quick disconnect (B4) from the male quick disconnect (B3). Open valve B2. The tank will depressurize.

Notes

Parts B-D can be installed into ports B-D interchangeably, however E parts must be installed on port E.

All threaded connections should be made with thread seal tape.

The system will be housed in an REI Ruck Pack 40.

It is not possible to remove the lid (A2) when the tank (A1) is pressurized.

When not in use, the lid (A2) should be secured to prevent paint in the tank (A1) from drying.

I claim:

1. A pack-mounted gas-pressurized timber marking paint system for marking trees and/or stumps comprising:
a pressurized source of gas in fluid communication with a lead line coupled with said source of gas via a pressure regulator, said lead line removably coupled to a first manifold on said pressurized source via a first port;
said lead line coupled with a storage tank via a storage tank port through a tank manifold, at least one of said first manifold and said tank manifold comprising a pressure shut-off valve;
a dispensation line in fluid communication with said storage tank via spray port, said dispensation line comprising a first end coupled to said storage tank, and a second end coupled to an emitter.

2. The timber marking system of claim 1 wherein said pressurized source of gas and said storage tank are housed within a shoulder-mountable back pack.

3. The timber marking system of claim 2 wherein said pressurized source of gas and said storage tank am stored within separable pockets within said back pack.

4. The timber marking system of claim 1 wherein said dispensation line is coupled with a second valve, said second valve comprising a ball valve or gat valve mounted on a third manifold mounted to said storage tank via said spray port.

5. The timber marking system of claim 1 wherein said emitter comprises a trigger-actuated spray gun.

6. The timber marking system of claim 1 wherein said storage tank comprises at least a third port, said third port comprising an pressure gauge.

7. A method of marking timber with a pressurized tank sprayer system, said method comprising the steps of:
filling a storage tank with a marking paint;
closing the storage tank with a pressure sealing lid;
coupling a pressure source tank with the storage tank via regulated pressure line from the pressure source tank to the storage tank via a pressure manifold;
attaching a supply line to a supply manifold set at a supply port in the storage tank;
opening the source tank to provide pressurized gas to the storage tank through the regulated pressure line and the pressure manifold;
providing an emitter to a far end of the supply line;
selectively emitting paint via the emitter onto a trunk of a targeted tree;
again selectively emitting paint via emitter onto a lower stump of the targeted tree;
closing a valve on the pressure manifold to terminating fluid communication between the storage tank and source tank to isolate the source tank.

8. The method of claim 7 further comprising the steps of
removing source line to manifold;
releasing pressure from storage tank by opening a valve in the pressure manifold.

9. The method of claim 8 further comprising the steps of:
opening storage tank lid;
refilling the storage tank;
resealing the storage tank.

10. The method of claim 9 further comprising the steps of:
reattaching the pressure line to the pressure manifold;
adjusting the pressure regulator open to supply pressurized gas to the storage tank.

11. The method of claim 7 further comprising the steps of:
identifying a target tree for removal prior to said step of selectively emitting;
whereby said steps of selectively emitting and again selectively emitting are conducted on the target tree.

12. The method of claim 7 further comprising the step of removing the marked tree by uprooting or cutting.
